(19) United States
(12) Patent Application Publication
(10) Pub. No.: US 2003/0154134 A1
(43) Pub. Date: Aug. 14, 2003

(54) Server based auction software

(76) Inventor: Fei Wang, Hermosa Beach, CA (US)

Correspondence Address: GREENBERG & LIEBERMAN, 314 PHILADELPHIA AVE., TAKOMA PARK, MD, 20912, US

(21) Appl. No.: 09/682,436

(22) Filed: Aug. 31, 2001

(51) Int. Cl. G06F 17/60

(52) U.S. Cl. 705/26

(57) ABSTRACT

A server side software program that uses both ASP and Sequel technology, and allows sellers and buyers to easily enter and bid on items in an online auction. There are management techniques included that allow the sellers to generate sales reports, create buyers reports, generate shipping information and track particular items.

### BACKGROUND OF THE INVENTION

The present invention is a server side software program for holding and facilitating auctions based on the Internet. More specifically, the present invention is a ASP and Sequel based database for loading and uploading pictures, descriptions, for auction items and holds a customer database, for bookkeeping, customer inquiries, shipping information, and other auction related tools.

Internet Auction sites are growing in popularity and number and are becoming a major way for small sellers to target larger audiences with their products. Internet auction houses require the sellers to enter their information one item at a time, and upload their pictures using “click and drag” technology which can take quite a bit of time, and requires their home computer to be able to sustain the complicated functions of transferring the files and running other programs.

Also most auction sites require that the user enter each picture or item separately. This creates an inherent problem if a seller has many items they wish to post, as they must enter each picture and item separately instead of being able to enter all pictures and items at once. Additionally, auction sites as they currently function do not allow the user to enter their sales information on many online auction sites at once, only the site on which they are currently registered.

U.S. Pat. No. 6,202,051 issued to Woolston on Mar. 13, 2001 for Facilitating Internet commerce through internetworked auctions. Woolston's invention is unlike the present invention because it does not allow a seller to use batch technology to enter many items for sale at once, and does not have a function to allow the seller to enter the items on the server and then denote exactly which auction sites to which they wish to upload the information. Also, Woolston's does not have basic office functions such as bookkeeping and receipt functions.

U.S. Pat. No. 6,161,099 issued to Harrington, et al., on Dec. 12, 2000 shows a process and apparatus for conducting auctions over electronic networks. Harrington's invention is unlike the present invention because it is for municipal bonds sales only, it does not have batch item functions, and it does not have picture docking to better enable picture uploading. Harrington's invention is also unlike the present invention because it does not allow individual sellers to post items to many auctioneers but instead only allows the user to access a particular auction house and the items available through that house.

U.S. Pat. No. 6,151,589 issued to Aggwaral, et al., on Nov. 21, 2000 for methods for performing large-scale auctions and online negotiations. Aggwaral's invention is unlike the present invention because it is a method for a software program that extends bids for a particular auction to other auctions, but it does not provide a function for sellers to post an item or a series of items to many auctions. Also Aggwaral's invention is unlike the present invention because it does not have a batch system so that a seller may enter several items at once to many auction sites, and it does not have a picture docking system to allow a seller to upload a large number of pictures, in one file transfer, with the files then being docked in a file so the seller may describe each individually.

U.S. Pat. No. 6,064,981 issued to Barni, et al., exhibits a method for online display and negotiation of cargo rates. Barni's invention is unlike the present invention because it is solely for cargo and freight rates, and not other items. Generally Barni's invention is a system to allow customers to compare prices of freight companies, and gives contact information for the company so the customer may negotiate posted rates. It is not a system of online auction that allows a seller to post many different items with pictures and descriptions to a central database, and submit that information to many different online auctions.

U.S. Pat. No. 5,966,699 issued to Zandi on Oct. 12, 1999 shows a system and method for conducting loan auction over computer network. Zandi's invention is unlike the present invention because it is intended to connect prospective borrowers to lending companies, and it holds the prospective borrower application in a database for a predetermined amount of time so the loan officers may go to that site and view the information, instead of disseminating the application to the lenders. Zandi's invention due to the nature of loan applications would not function for sellers attempting to post several items for sale on many different auction houses, and does not allow batch placement of these items at the various auction houses.

U.S. Pat. No. 5,890,538 issued to Godin, et al., on Mar. 30, 1999 shows a computer auction system. Godin's invention is unlike the present invention because it is a singular auction system and does not provide a server based database system for sellers wishing to sell many products on more than one auction site. Also it does not provide batch technology so that a seller may enter many items for sale at one time to an auction site. Also since Godin's invention is one site it does not provide sellers the ability to do basic bookkeeping functions, such as charts or graphs of what items are selling at a faster rate on which site. It also does not provide customer inquiries to determine not only reports on a particular item, but a history of all sales to that customer.

Japanese patent No. 2,000,099,594 issued to Eiichi, et al. on Apr. 7, 2000 exhibits a sales stock management system and storage program for realizing the system. Eiichi's invention is unlike the present invention because it is a system for allowing a company to keep track of shipping costs and merchandise, but is not an auction system.

Japanese patent No. 10,312,413 issued to Katsuhiko on Nov. 24, 1998 shows a management analysis system. Katsuhiko's invention is unlike the present invention because it is a management system for sales only, and does not provide for auction functions or databases.

Therefore a need has been established for a software program that can upload many pictures and items at one login, can allow sellers to use batch technology to send many items at once to several different auction houses. Also a need has been established for an auction software system that also uses technology to upload a stack of pictures from the seller's computer in a quick manner at once, instead of one picture at a time. It is the opinion of the applicants that the present invention is unique non-obvious from any related art.

### SUMMARY OF INVENTION

The present invention is a server side software program that uses both ASP and Sequel technology, and allows sellers and buyers to easily enter and bid on items in an online auction. There are management techniques included that allow the sellers to generate sales reports, create buyers reports, generate shipping information and track particular items.

A seller may enter as many items as needed at one time through the software program. There is a function that allows the seller to transfer as many pictures as needed for one login at once. The seller may then open each picture and type a description, a preferred starting price, an ending date for the auction and any other pertinent information in the database. This is unique to the invention because current technology on existing auction sites require the seller to enter one picture and description per login, and the picture transfer is usually transpired by a click and drag function which is a much slower file transfer.

After the seller has entered their item or items they may then indicate which auction sites that they wish to post the items on and the server will place the description and pictures using a batch method at one time to each auction indicated. This is unique to the present invention because if a seller enters items on an auction site themselves they must enter each item separately and through separate logins, slowing the process of getting the items onto the auction web site and making them available to bidders.

### BRIEF DESCRIPTION OF DRAWINGS

FIG. 1 shows a view of the Upload Images screen.

FIG. 2 shows a first part of the Item Description screen.

FIG. 3 shows the second part of the Item Description screen.

FIG. 4 shows the third part of the Item Description screen.

FIG. 5 shows the Ebay Accounting Screen.

FIG. 6 shows the add users screen under Human Resources.

FIG. 7 is a flow chart of the main interface.

FIG. 8 is a flow chart of the upload images functions.

FIG. 9 is a flow chart of the upload items function.

FIG. 10 is a flow chart of the upload items item list code routines.

FIG. 11 is a flow chart of the sales option and the item modification functions.

FIG. 12 is a flow chart of the compose to Ebay option of the present invention.

FIG. 13 is a flow chart of the upload to Ebay option of the present invention.

FIG. 14 is a flow chart of the record Ebay option of the present invention.

FIG. 15 is a flow chart of the first part of the shipping cost.

FIG. 16 is a flow chart of the second part of the shipping cost.

FIG. 17 is a flow chart of the third part of the shipping cost.

FIG. 18 is a flow chart of Part 1 of the relist to Ebay function.

FIG. 19 is a flow chart of Part 2 of the relist to Ebay function.

FIG. 20 is a flow chart of Part 3 of the relist to Ebay function.

FIG. 21 is a flow chart of the shipment, payment received function.

FIGS. 22 and 23 are the first and second part of the print document function of the shipment section.

FIG. 24 is a flow chart of the shipment section and the ship out function.

FIG. 25 is a flow chart of the shipment section and feed back function.

FIG. 26 is a flow chart of the account follow section.

FIG. 27 is a flow chart the Account Follow section, Refund function of the present invention.

FIG. 28 is a flow chart of the Ebay History functions of the Account Follow section.

FIG. 29 is a flow chart of the Customer service function of the account follow section.

FIG. 30 is a flow chart of the Management section and lots location function.

FIG. 31 is a flow chart of the Management section and Ebay Accounting sections.

FIG. 32 is a flow chart of the human resources function of the management section.

FIG. 33 is a flow chart of the log out function of the present invention.

### DETAILED DESCRIPTION

The first screen that the users encounter is a conventional login screen in which the customer enters their User ID that they have been assigned and they input the password that they have chosen.

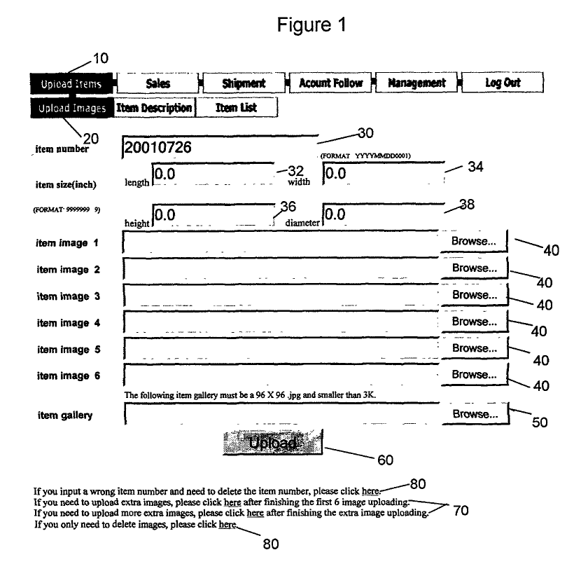

FIG. 1 shows the Upload images screen. The user may login to the system and upload items. Under the upload items (10) option the user may start with uploading images (20). The upload images (20) screen begins with a space for the item number (30), which are a European date system, and a 3-digit number. For example the first item entered into the database could be 20010101001, for the first item entered on Jan. 1, 2001. The user then enters the length (32), width (34), height (36) and diameter (38) of the item in inches. Each of the measurements (32,34,36,38) can be input to the nearest tenth of an inch. The user may enter up to six individual images (40), and/or an item gallery (50). The item gallery (50) allows the user to enter a series of pictures of the item. The item gallery (50) must be in jpeg format and no larger than 96×96 or 3 KB in size. A unique feature of the present invention is that the user may browse for and select the 6 individual pictures (40), and the item gallery (50) and then upload (60) them at once to the auction database. The user may also use a series of sub-commands at the bottom of this screen to enter more images, if they prefer more than 6 pictures (70). There are also sub-commands for clearing and correcting the item number and for deleting images if necessary (80).

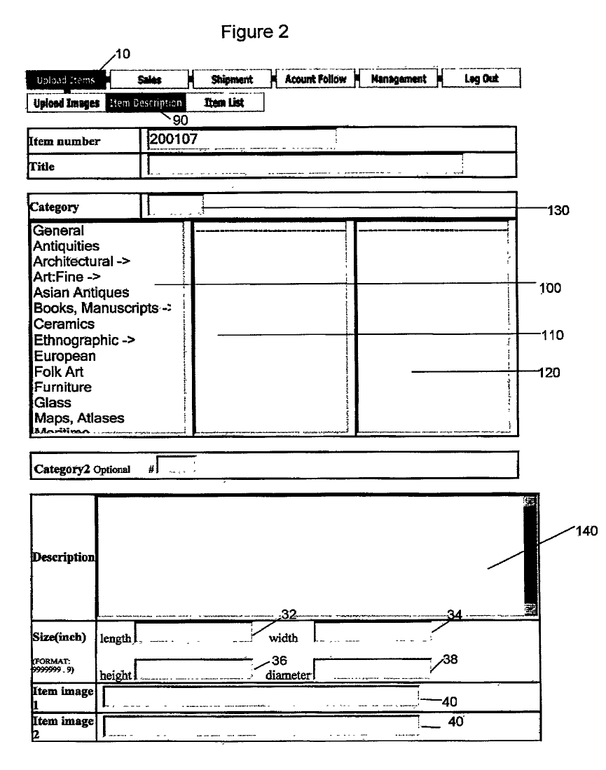

The next option under upload items (10) is the Item description (FIG. 2, 90) page. The Item description (90) page has a scrolling menu (100) format in which the user may choose key words to decide which categories their item is auctioned under, and what buyers may easily search on. Some of the primary categories (100) have secondary categories (110), and some of the secondary categories (110) also have tertiary categories (120).

For example if the user has an autograph that they wish to auction. They will start with the Memorabilia option in the first scroll menu (100). In the second scroll menu (110) they will see the options of: General, Autographs, Celebrity, Hollywood, Movie, Movie:Current, Television, Theater. Upon clicking on the Autographs option the third menu (120) give additional choices of general, movies, television, theater. Therefore if the user has an autograph from John Wayne, the choices would be Memorabilia, Autographs, and Movies. Any choice that the user chooses for any item provide a numeric code (130), to allow the user easier tracking of the items, and to allow for easier filing in the database system.

After the user chooses the categories they wish to file their item under, they may then enter a paragraph description (140) of the item. The measurements (32, 34, 36, 38) entered in the Upload Images Screen, and the images (40) themselves are carried over and shown to the user.

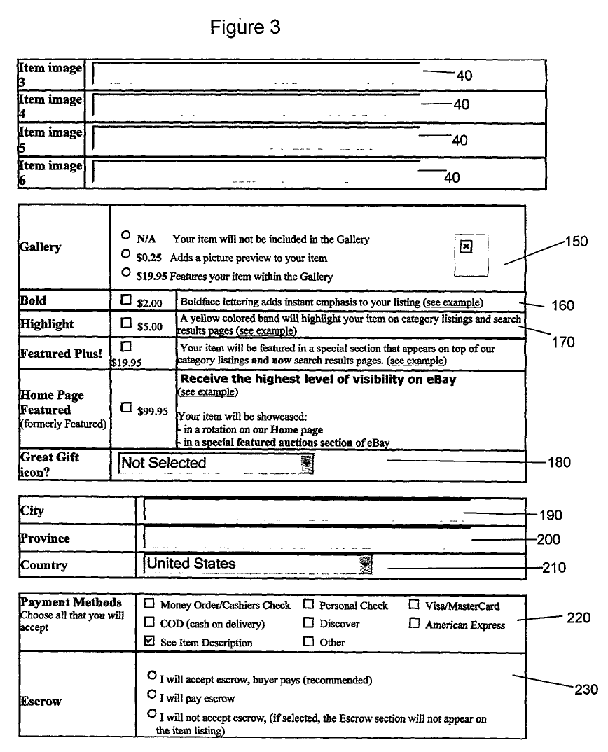

As shown in FIG. 3, the user then has options to add the photo or photos to the photo gallery (150), or for a less expensive spenditure the user may add a picture preview. They can also pay small fees to either highlight (170) their description or to make it bold face print (160). They can also pay to have their home page showcased. There is also an option to enter a “Great Gift” icon (180), to catch the buyer's eye. Under the great Gift option (180) the user may choose from the following categories: Anniversary, Baby, Birthday, Christmas Day, Easter, Father, Graduation, Halloween, Hanukkah, July 4^{th}, Mother, St. Patrick, Thanksgiving Valentine, and Wedding.

The user then enters some basic information on themselves, the city (190) province (200) and country (210). Next the user chooses the methods of payment (220) that they will accept. The available options of payment (220) are: Money Order/Cashiers Check, Personal Check, COD, Visa/Mastercard, Discover, American Express, Other, and See Item Description. There is also an option to include preference regarding acceptance and responsibility of escrow (230).

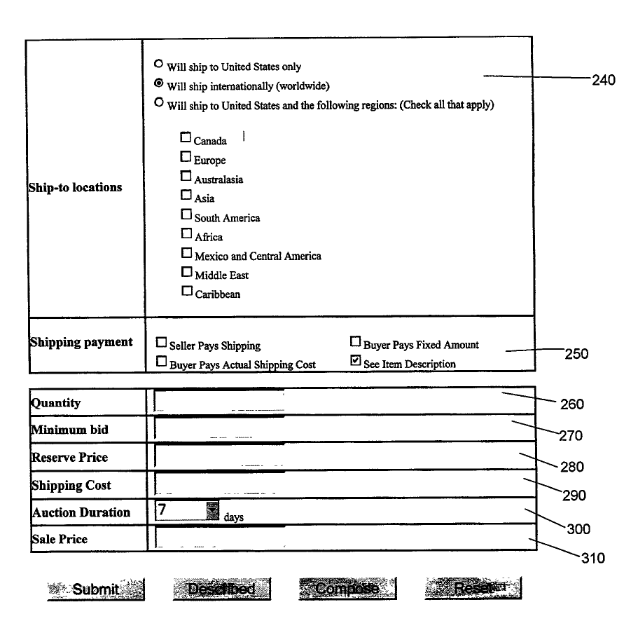

The next major section of the page (FIG. 4) is the shipping section. In the shipping section the user can enter where they will ship (240) to and who will pay for shipping (250) for the item. Finally, the user enters the quantity (260)of the item that they have available, minimum bid (270), reserve price (280), shipping cost (290), auction duration (300), and sale price at end of auction (310). The user may also go to the item list page to view any items that they have had that are sold pending, or new. They can also delete any entries that they have completed and no longer need. Under the sales option there is an Item Modification screen, appears in the same manner as the Item Description (90) page. The user may change any or all of the categories or paying options on the item modification screen. They may also change shipping locations, quantity available, minimum bid, and change or add uploaded images.

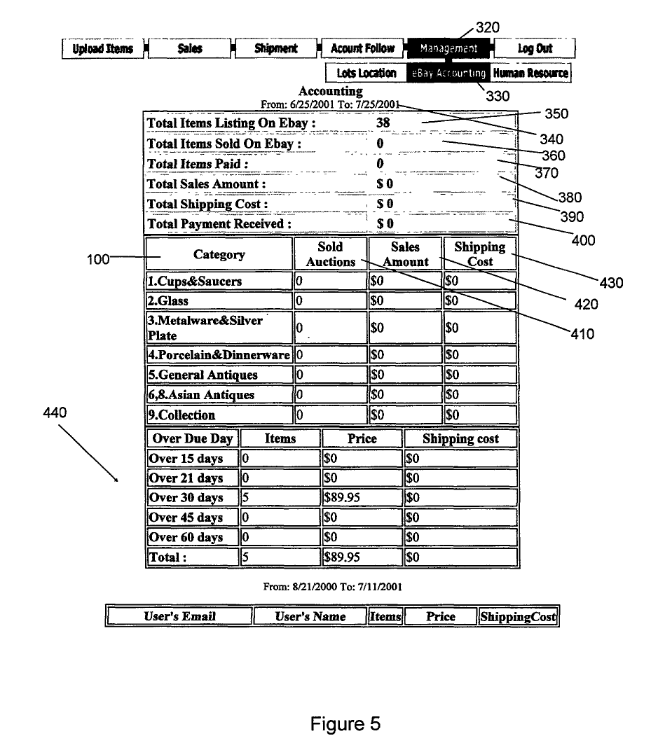

As shown in FIG. 5, under the Management (320) function is the Ebay Accounting (330) screen. It can be inferred from the present invention that any screen directed toward Ebay can be directed toward any online auction community. This screen shows the accounting for a one-month period (340). There is an accounting of the total item listed on Ebay (350), total items sold (360), and total items paid (370). There is also a blank for total sales amount (380), total shipping cost (390), and total payment received (400). There is a table that has the primary catalogue (100) from the item description page (90). Also in this table is the sold auctions (410), sales amounts (420) and shipping costs (430). There is also an over due day chart (440) also so the user may view which payments or items are overdue on increments of 15 days.

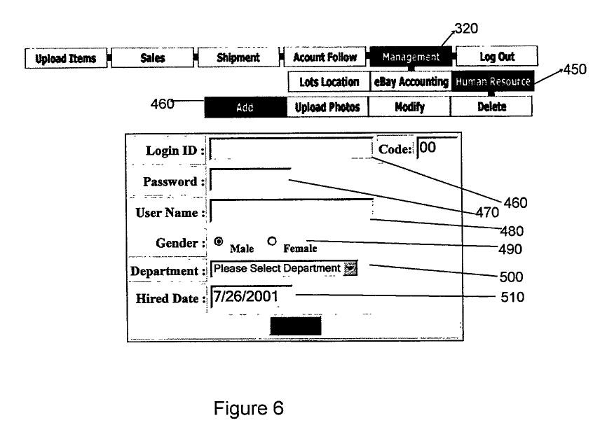

As shown in FIG. 6, under management (320), and human resources (450), there is also an Add (460) function where the user may add new employees that need to have access to the database for their items. On this screen they enter a login ID (520), user ID (480) and password (470), as well as gender (490), department (500) and hired date (510). In this manner if necessary the company may have knowledge of what changes were made under which login.

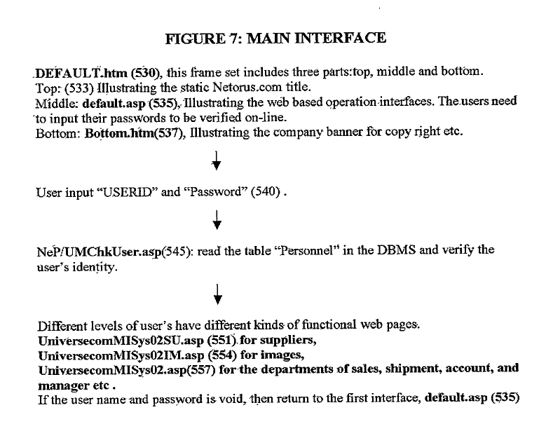

As shown in FIG. 7 the main interface has an upper section the default.htm (530) has three subsections the title (533), the default.asp (535), And the bottom.htm (537) The title section (533) shows the title or the company name. The default.asp (535) illustrates the web-based operations, and the space for the users to enter password that is verified online. The bottom.htm (537) shows the copyright code or a place for the company banner. The next section is the user id and password input (540) which send the login information to be verified online through the database. The user id and password input (540) is case sensitive and requires the user to login for each use of the database.

The user id and password input (540) sends the user login through use of NeP/UMChkUser.asp (545) to the personnel chart in DBMS to verify the user's identity and allow or disallow the login. After entering a valid login the user will be directed to one of three pages due to their clearance.

UniversecomMISys02SU.asp (551) is the code category for suppliers' opening page. UniversecomMISys02IM.asp (554) is the opening page for entering images (40). UniversecomMISys02.asp (557) is the opening page for sales, shipment, manager, and accounting. If the login is invalid the user is pushed back to the default.htm (535) screen.

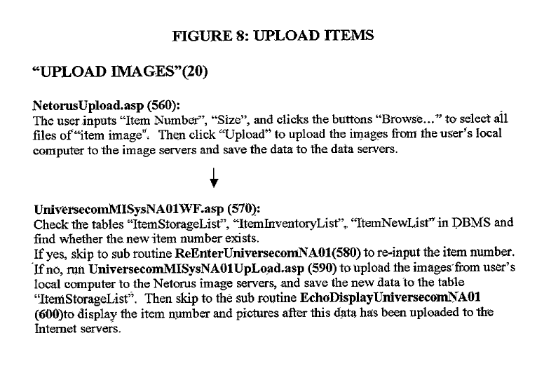

FIG. 8 shows a flow chart of the programming involved in the upload items (10) screen. Under upload items (10) is the upload images (20) screen. The code NetorusUpload.asp (560) allows the user to input the item number (30), size (32, 34, 36, 38), and select the images (40). The user may browse their files and choose the pictures from their hard drive. The user may also press the upload (60) function and load the pictures to the database. All of the above options are controlled by the NetorusUpload.asp (560) routine.

The NetorusUpload.asp (560) leads to the UniversecomMISysNA01WF.asp (570) from the item number (30) section. UniversecomMISysNA01WF.asp (570) checks the Item Storage List, Item Inventory list, and the Item new list to determine if the new item number (30) exists. If the item number exists the sub routine of ReEnterUniversecomNA01 (580) is executed to allow the user to re-enter a new item number (30). If the item number (30) has not been used previously, the sub routine of UniversecomMISysNA01 UpLoad.asp (590) is executed to upload the images from the user's computer to the image servers, and the new data to a Item Storage List table. The next sub routine EchoDisplayUniversecomNA01 (600) runs in the background to allow a display of the item number (30) and pictures after the data has been transferred online.

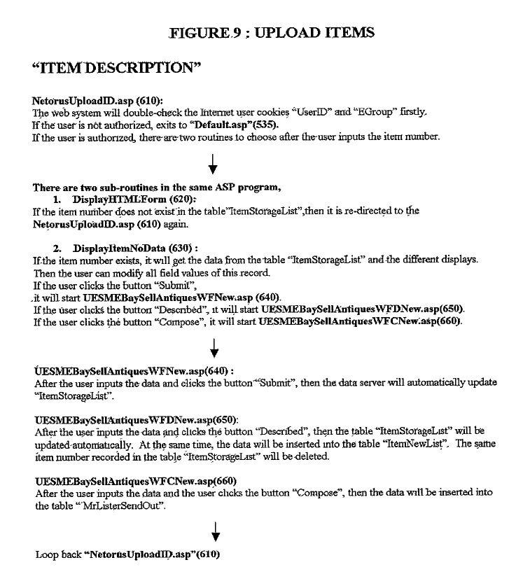

FIG. 9 shows the routines and sub routines of code for additional options under the upload items (10) option. NetorusUploadID.asp (610) first checks the UserID and Egroup cookies to determine if the user is authorized. If the user is not authorized the routine is executed from NetorusUploadID.asp (610) to return the user to default.asp (535). If the user is authorized there are two choices after the user inputs the item number (30). The available sub routines at this point are the DisplayHTMLForm (620) subroutine, which will return the user to NetorusUploadID.asp (610) if the item number (30) is incorrect so they may enter again. If the item number (30) exists the sub routine DisplayItemNoData (630) is executed to pull the information from the Item Storage List and allows the user to modify the records. If the user hits the submit button the sub routine UESMEBaySellAntiquesWFNew.asp (640) is started. If the user clicks the button described the sub routineUESMEBaySellAntiquesWFDNew.asp (650) will be started. If the user clicks the button compose the routineUESMEBaySellAntiquesWFCNew.asp (660) is started. After either UESMEBaySellAntiquesWFNew.asp (640), UESMEBaySellAntiquesWFDNew.asp (650) or UESMEBaySellAntiquesWFCNew.asp (660) the user can hit the submit button which will initiate UESMEBaySellAntiquesWFNew.asp (670) and automatically update the Item Storage List table in the database. UESMEBaySellAntiquesWFDNew.asp (650), executed after the user clicks the button described, the Item Storage List is updated instantaneously, the data is recorded to the Item new list table, and the item number recorded in the Item Storage List is deleted. The deletion keeps the database up to date with the latest information only, and creates a situation in which the database will not advertise the wrong description, or duplicate descriptions of the item. After the user clicks the compose button UESMEBaySellAntiquesWFCNew.asp (660) is activated and sent to the Mr Lister Send Out table to be queued to the online auction. At this point the user is looped back to NetorusUploadID.asp (610), described in detail above.

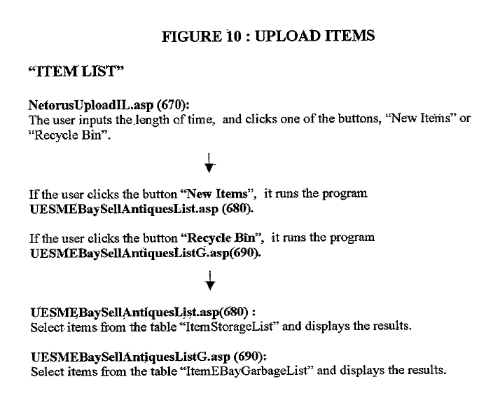

FIG. 10 shows the item list function under the upload items option. NetorusUploadIL.asp (670): is run when the user hits the buttons New Items, or the Recycle Bin button. If the user presses the button New Items the sub routine UESMEBaySellAntiquesList.asp (680) is initiated. If the user presses the Recycle Bin button the UESMEBaySellAntiquesListG.asp (690) sub routine is initiated.

UESMEBaySellAntiquesList.asp (680) selects the appropriate items from the Item Storage List and displays the results. UESMEBaySellAntiquesListG.asp (690) selects the appropriate items from the table Item Ebay Garbage List.

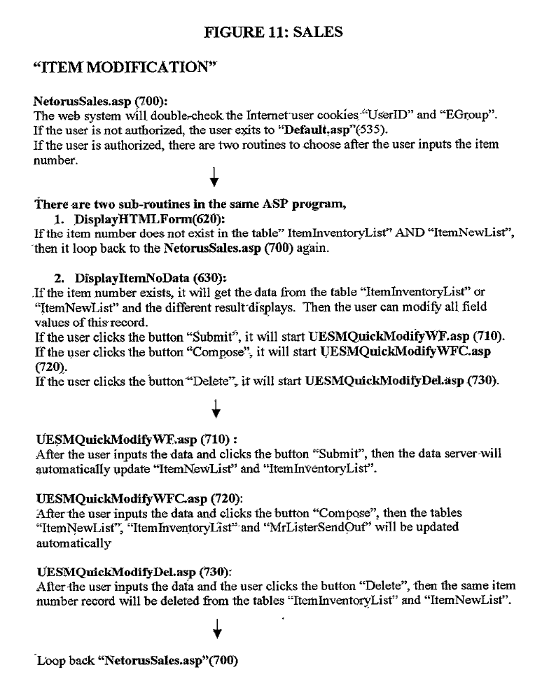

FIG. 11 shows the item modification section under the sales option. The first routine is NetorusSales.asp (700) in which the database double checks the UserID and Egroup as entered initially, and if they do not allow access the user is looped back to the default.asp (535) screen. If the user meets authorization requirements they can input the item number (30), which allows for one of two subroutines. The first option is DisplayHTMLForm (620) if the item number (30) entered does not match the numbers in either table Item Inventory List, and the Item New List and then loops back to NetorusSales.asp (700) so the user may enter another item number (30). The second option is DisplayItemNoData (630). If the item number entered exists, the data is pulled from the Item Inventory List or the Item New List and displays the results so the user may modify them.

If the user then clicks the Submit button the sub routine UESMQuickModifyWF.asp (710) is initiated. If the user hits the button Compose UESMQuickModifyWFC.asp (720) is started. If the user clicks the button Delete the sub routine UESMQuickModifyDel.asp (730) is started. UESMQuickModifyWF.asp (710) tells the data server will automatically update the Item New List and the Item Inventory List. UESMQuickModifyWFC.asp (720) updates the Item New List, the Item Inventory List, and Mr Lister Send Out lists, after the user hits the compose button. UESMQuickModifyDel.asp (730) is initiated when the user hits the delete button, and deletes the item number record from the Item Inventory List and the Item New List. The user is then looped back to the main screen by use of the NetorusSales.asp (700) routine.

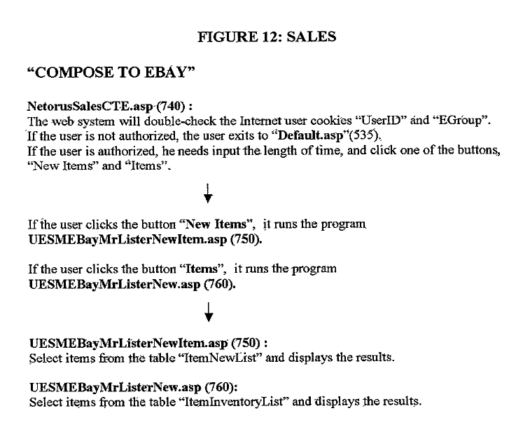

FIG. 12 shows the Compose to bay option under the sales function. The first routine used under the Compose to Ebay option is NetorusSalesCTE.asp (740). NetorusSalesCTE.asp (740) first checks the UserID and Egroup to determine they are valid and the user is authorized. If the user is not authorized they are looped back to Default.asp (535). If the user is authorized they will input the length of time, and then click either the New Items or the items buttons. If the user clicks the New Items the sub routine UESMEBayMrListerNewItem.asp (750) is executed. If the user presses the items button, UESMEBayMrListerNew.asp (760) is started. UESMEBayMrListerNewItem.asp (750) selects the appropriate items from the Item New List table and displays the results. UESMEBayMrListerNew.asp (760) selects the appropriate items from the Item Inventory List and displays the results.

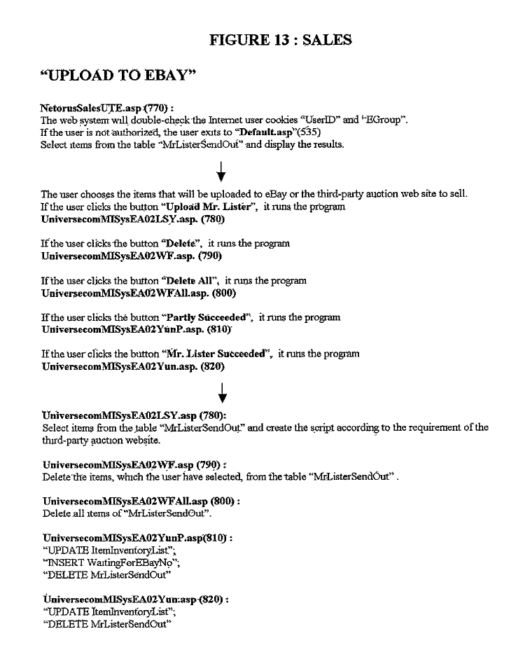

FIG. 13 shows in the Upload to Ebay option that NetorusSalesUTE.asp (770) route to Default.asp (535) or UniversecomMISysEA02LSY.asp. (780) or UniversecomMISysEA02WF.asp. (790) or UniversecomMISysEA02WFAll.asp. (800) or UniversecomMISysEA02YunP.asp. (810) or UniversecomMISysEA02Yun.asp. (820).

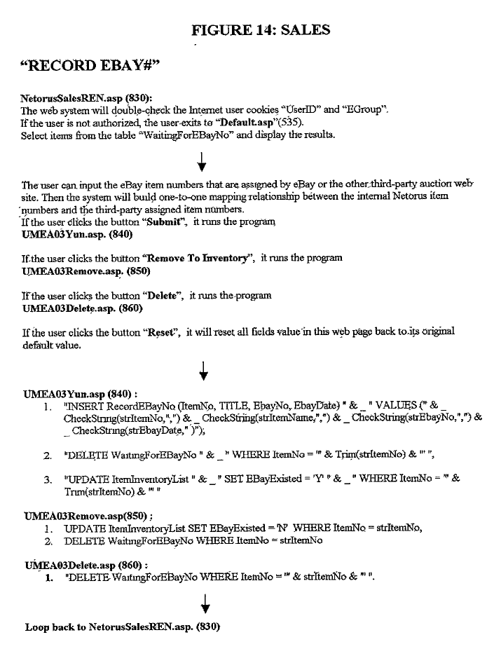

FIG. 14 shows In the Record Ebay # that NetorusSalesREN.asp (830) leads to Default.asp (535) or UMEA03Yun.asp. (840) or UMEA03Remove.asp. (850) or UMEA03Delete.asp. (860) and then loops back to NetorusSalesREN.asp. (830).

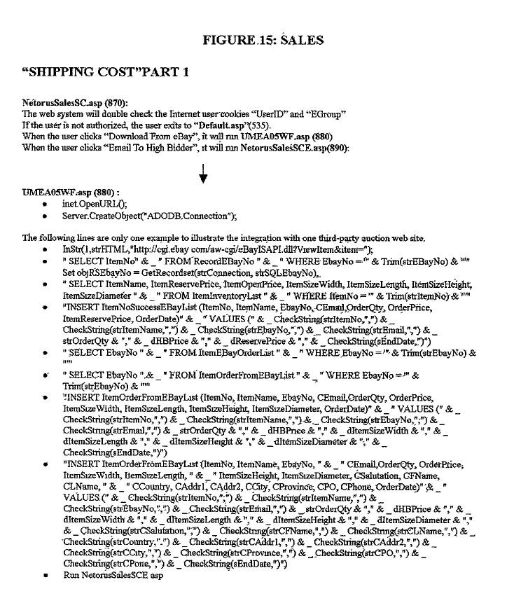

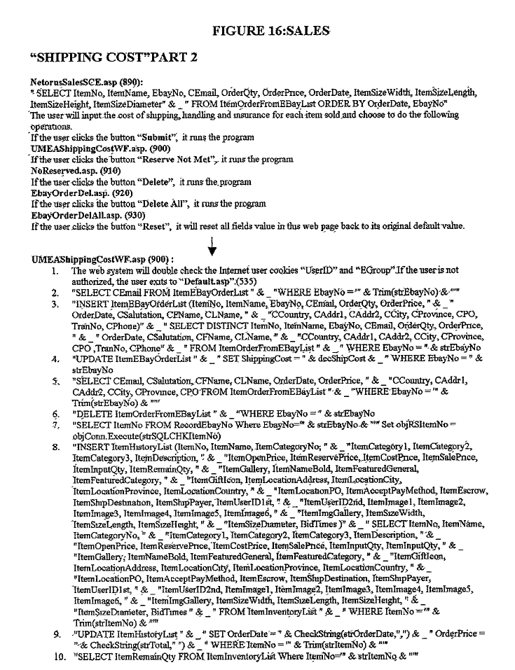

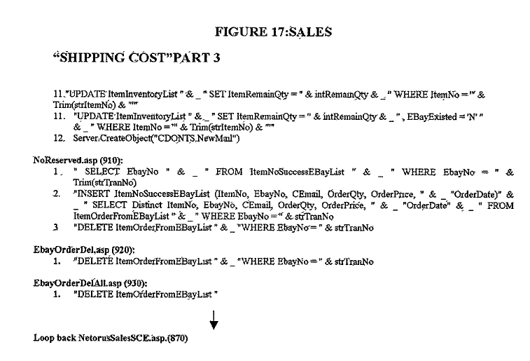

FIG. 15 shows the first part of the shipping cost section under sales. Please also see the FIGS. 16 and 17 for the continuation of the shipping cost section. The shipping cost section starts with NetorusSalesSC.asp (870) and leads to Default.asp (535), UMEA05WF.asp (880) or NetorusSalesSCE.asp (890). In FIG. 16 it is shown that NetorusSalesSCE.asp (890) can lead to UMEAShippingCostWF.asp. (900), NoReserved.asp. (910), EbayOrderDel.asp. (920) or EbayOrderDelAll.asp. (930). UMEAShippingCostWF.asp (900) can lead to Default.asp (535) if non-authorized. FIG. 17 shows that UMEAShippingCostWF.asp. (900), NoReserved.asp. (910), EbayOrderDel.asp. (920) or EbayOrderDelAll.asp. (930) loop back to NetorusSalesSC.asp (870).

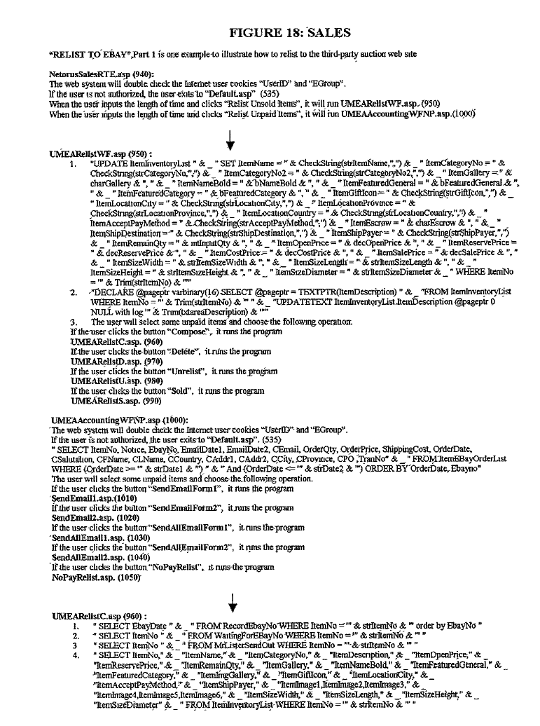

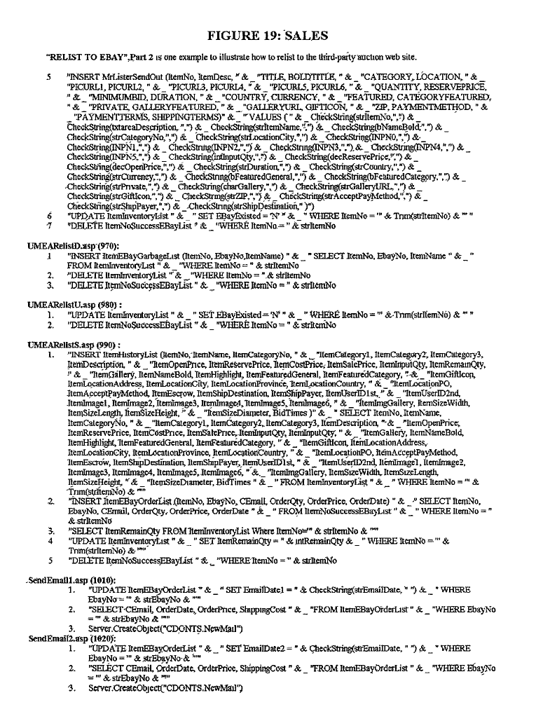

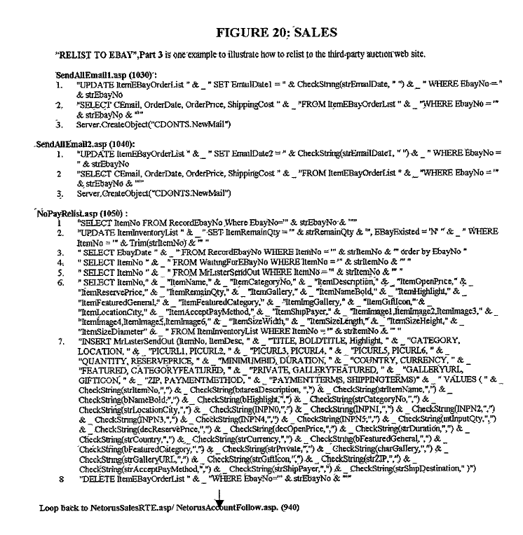

FIG. 18 is a flow chart of the Relist to Ebay function, and is part 1, of 3. FIG. 18 should be studied in conjunction with FIGS. 19 and 20 showing parts 2 and 3 of the relist to Ebay function. FIG. 18 shows NetorusSalesRTE.asp (940) can lead to UMEARelistWF.asp. (950), or UMEAAccountingWFNP.asp. (1000). UMEARelistWF.asp (950) can lead to UMEARelistC.asp. (960), UMEARelistD.asp. (970), UMEARelistU.asp. (980), or UMEARelistS.asp. (990).

UMEAAccountingWFNP.asp (1000) can lead to Default.asp (535), SendEmail1.asp. (1010), SendEmail2.asp. (1020), SendAllEmail1.asp. (1030), SendAllEmail2.asp. (1040), or NoPayRelist.asp. (1050). UMEARelistC.asp (960) is also further explained at the end of FIG. 18. FIG. 19 begins with further explanation of UMEARelistC.asp (960). Explanations of UMEARelistD.asp (970), UMEARelistU.asp (980), UMEARelistS.asp (990), SendEmail1.asp (1010), and SendEmail2.asp (1020). FIG. 20 is a flow chart of Part 3 of the Relist to Ebay function. Explanations of SendAllEmail1.asp (1030), SendAllEmail2.asp (1040), and NoPayRelist.asp (1050). At the bottom of FIG. 20 is shown the end of the programming chart NetorusSalesRTE.asp/NetorusAccountFollow.asp. (940).

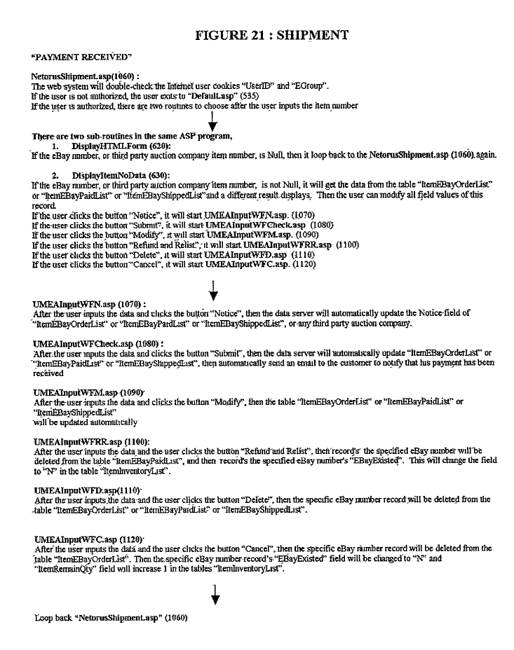

FIG. 21 is a flow chart of the payment received under the shipment function of the present invention. NetorusShipment.asp (1060) can lead to Default.asp (535), DisplayHTMLForm (620), or DisplayItemNoData (630). DisplayHTMLForm (620) will lead to NetorusShipment.asp (1060). DisplayItemNoData (630) can lead to UMEAInputWFN.asp. (1070), UMEAInputWFCheck.asp. (1080), UMEAInputWFM.asp. (1090), UMEAInputWFRR.asp. (1100), UMEAInputWFD.asp. (1110), or UMEAInputWFC.asp. (1120). UMEAInputWFN.asp. (1070), UMEAInputWFCheck.asp. (1080), UMEAInputWFM.asp. (1090), UMEAInputWFRR.asp. (1100), UMEAInputWFD.asp. (1110), and UMEAInputWFC.asp. (1120) are explained in detail. Each of these option leads back to NetorusShipment.asp (1060).

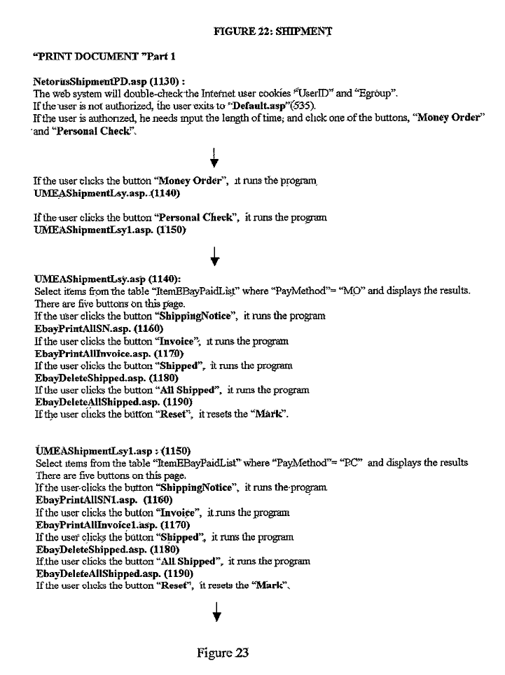

FIGS. 22 and 23 show the first and second part of the print document function of the shipment section. FIG. 22 shows NetorusShipmentPD.asp (1130) leads to either Default.asp (535), UMEAShipmentLsy.asp. (1140), or UMEAShipmentLsy1.asp. (1150). UMEAShipmentLsy.asp (1140): can route to EbayPrintAllSN.asp. (1160), EbayPrintAllInvoice.asp. (1170), EbayDeleteShipped.asp. (1180), or EbayDeleteAllShipped.asp. (1190). UMEAShipmentLsy1.asp: (1150) Can route to EbayPrintAllSN1.asp. (1160), EbayPrintAllInvoice1.asp. (1170), EbayDeleteShipped.asp. (1180) or EbayDeleteAllShipped.asp. (1190). FIG. 23 shows the shipment section print document, second part. FIG. 23 gives explanations of EbayPrintAllSN.asp (1160), EbayPrintAllSN1.asp (1200), EbayPrintAllInvoice.asp (1170), EbayPrintAllInvoice1.asp(1210), EbayDeleteShipped.asp (1180), and EbayDeleteAllShipped.asp (1190).

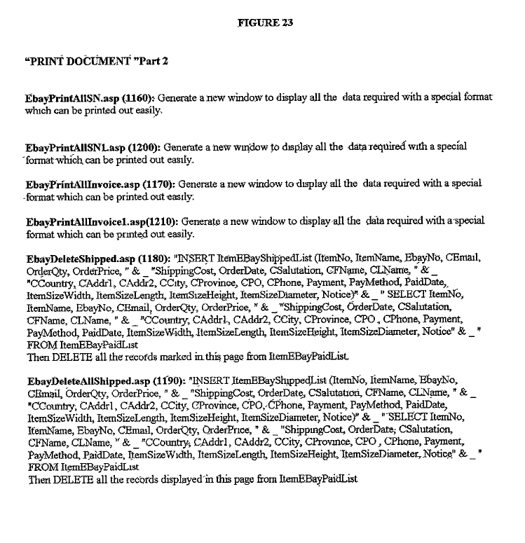

FIG. 24 is a flow chart of the shipment section and the ship out function. As is shown in FIG. 24, NetorusShipmentSO.asp (1220) can lead to Default.asp. (535), DisplayHTMLForm (620), or DisplayItemNoData (630). DisplayHTMLForm (620) loops back to NetorusShipmentSO.asp (1220). DisplayItemNoData (630) leads UMEAShipMarkWF.asp. (1230) or UMEAShipMarkWFR.asp. (1240). Explanations for UMEAShipMarkWF.asp. (1230) and UMEAShipMark.WFR.asp (1240) are also given in FIG. 24. Either UMEAShipMarkWF.asp. (1230) or UMEAShipMarkWFR.asp. (1240) loop back to NetorusShipmentSO.asp (1220) when complete.

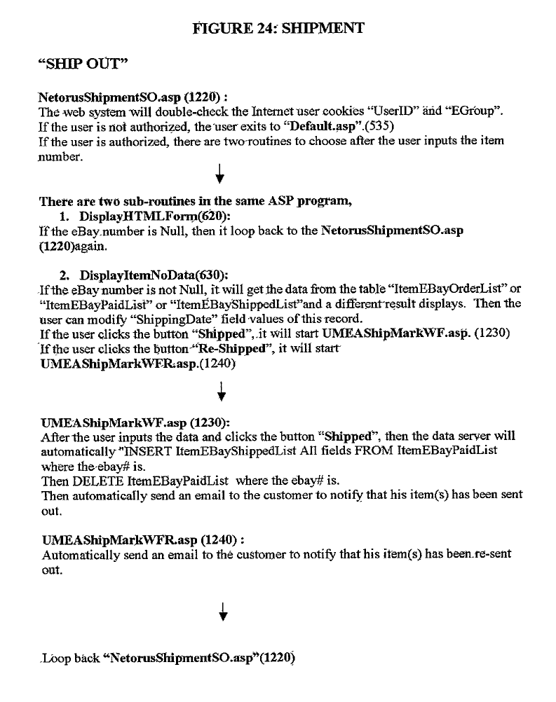

FIG. 25 shows a flow chart of the shipment section and feed back function. NetorusShipmentFB.asp (1250) can route to Default.asp (535) or UMEAFeedBack.asp. (1260). UMEAFeedBack.asp: (1260) will feed into UMEAFeedBackWF.asp (1270) which has separate functions depending on user input.

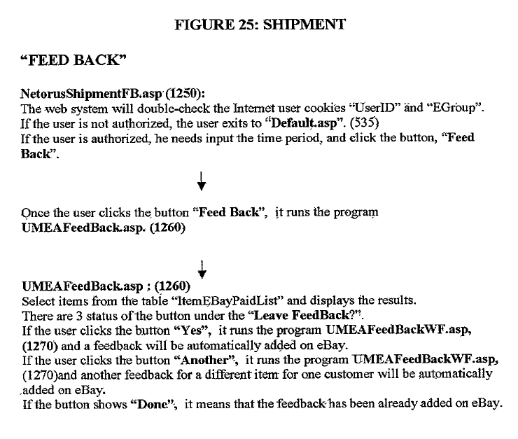

FIG. 26 is a flow chart of the account follow section. FIG. 26 shows that NetorusAccountFollow.asp (1280): can lead to Default.asp. (535), UMEAAF.asp. (1290), or UMEAAccountFollowMark.asp. (1300). UMEAAF.asp: (1290) can route to SendEmail1.asp (1010), SendEmail2.asp (1020), SendAllEmail1.asp (1030), or SendAllEmail2.asp(1040) UMEAAccountFollowMark.asp (1300) can lead to DisplayHTMLForm (620) or DisplayItemNoData (630). SendEmail1.asp (1010) in this routine can also lead UMEAAccountFollowMarkWF1.asp (1310), UMEAAccountFollowMarkWF2.asp (1320), or UMEAAccountFollowMarkWF3.asp (1330).

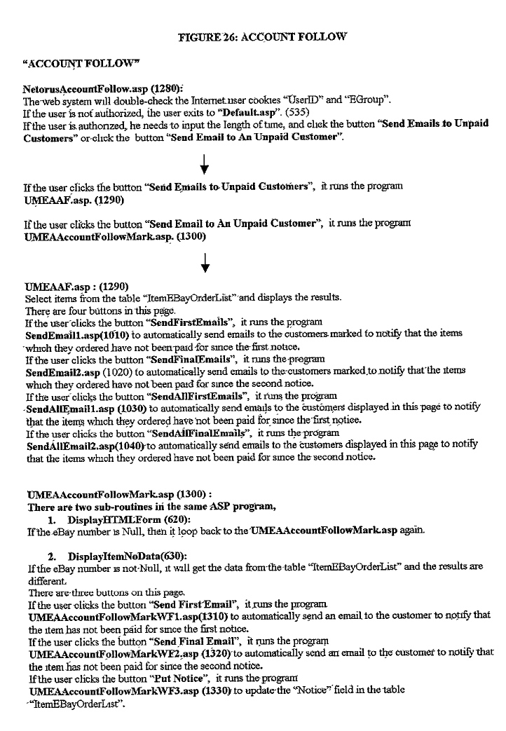

FIG. 27 shows the Account Follow section, Refund function of the present invention. FIG. 27 shows the first function NetorusAccountFollowR.asp (1340) which can lead to Default.asp (535), DisplayHTMLForm: (620) or DisplayItemNoData: (630). DisplayItemNoData: (630) can lead to UMEAERWF.asp. (1350) or UMEAERWFD.asp. (1360).

UMEAERWF.asp : (1350) and UMEAERWFD.asp (1360) Loop back toNetorusAccountFollowR.asp (1340) when completed.

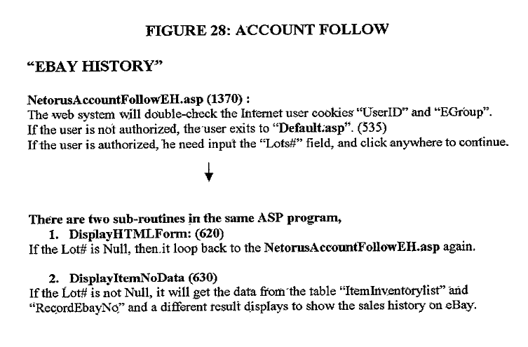

FIG. 28 shows the Ebay History functions of the Account follow section. The first function of the Ebay History is NetorusAccountFollowEH.asp (1370). NetorusAccountFollowEH.asp (1370) can lead to Default.asp (535), DisplayHTMLForm (620) or DisplayItemNoData (630).

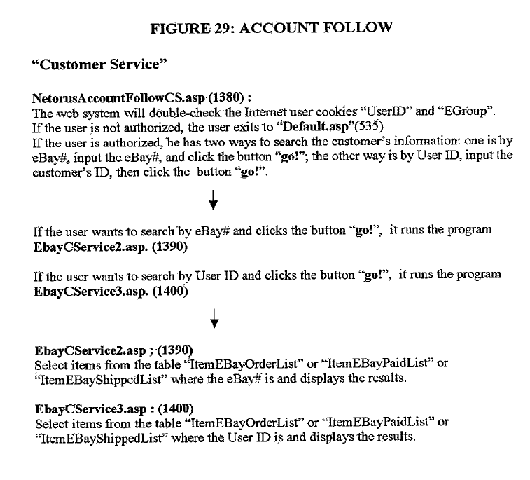

FIG. 29 shows the Customer service function of the account follow section. The first function of the customer service section is NetorusAccountFollowCS.asp (1380) which can lead to Default.asp (535), EbayCService2.asp. (1390), or EbayCService3.asp. (1400). EbayCService2.asp (1390) and EbayCService3.asp (1400) are explained as well in FIG. 29.

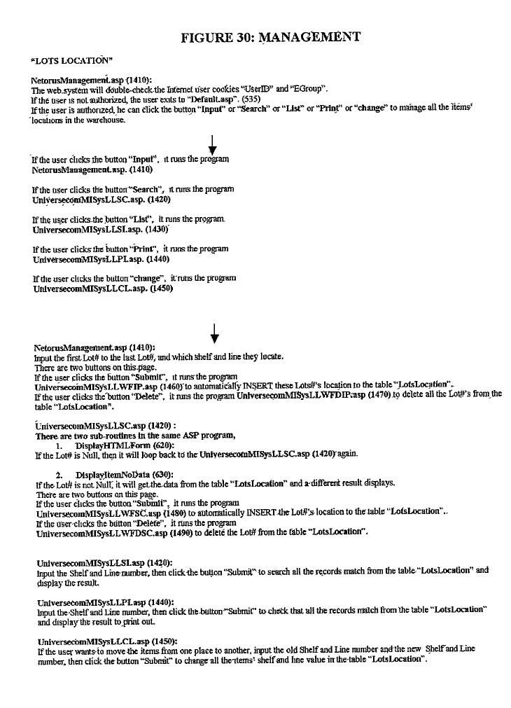

FIG. 30 is a flow chart of the Management section and lots location function. The first function on in this section NetorusManagement.asp. (1410) which can lead to cDefault.asp (535), UniversecomMISysLLSC.asp. (1420), UniversecomMISysLLSI.asp. (1430), UniversecomMISysLLPI.asp. (1440), or UniversecomMISysLLCL.asp. (1450). NetorusManagement.asp (1410) can also activate UniversecomMISysLLWFIP.asp (1460) or UniversecomMISysLLWFDIP.asp (1470), depending on options chosen by the user. UniversecomMISysLLSC.asp (1420) can lead to DisplayHTMLForm (620), or DisplayItemNoData (630). DisplayItemNoData (630): can also lead to UniversecomMISysLLWFSC.asp (1480), or UniversecomMISysLLWFDSC.asp (1490). Explanations of UniversecomMISysLLSI.asp (1420), UniversecomMISysLLPI.asp (1440), and UniversecomMISysLLCL.asp (1450) are also provided.

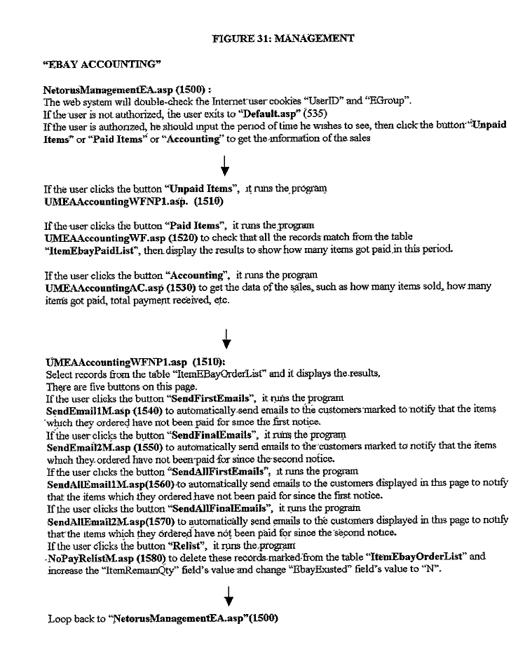

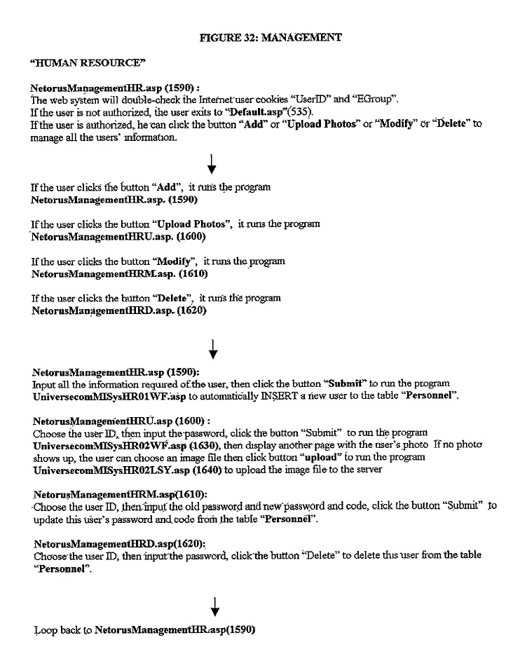

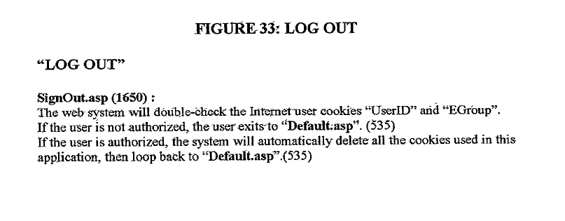

FIG. 31 shows the Ebay Accounting function of the Management section. NetorusManagementEA.asp (1500) as the first operation can route to Default.asp (535), UMEAAccountingWFNP1.asp. (1510), UMEAAccountingWF.asp (1520), or UMEAAccountingAC.asp (1530). UMEAAccountingWFNP1.asp (1510) can execute SendEmail1M.asp (1540), SendEmail2M.asp (1550), SendAllEmail1M.asp (1560), SendAllEmail2M.asp (1570), or NoPayRelistM.asp (1580). SendEmail1M.asp (1540), SendEmail2M.asp (1550), SendAllEmail1M.asp(1560), SendAllEmail2M.asp (1570), and NoPayRelistM.asp (1580) each loop back to NetorusManagementEA.asp (1500) upon completion. FIG. 32 shows the human resource function of the management section. NetorusManagementHR.asp (1590) can lead to Default.asp (535), NetorusManagementHRU.asp. (1600), NetorusManagementHRM.asp. (1610), NetorusManagementHRD.asp. (1620), or loop back to initial function NetorusManagementHR.asp (1590). NetorusManagementHRU.asp (1600) can also execute UniversecomMISysHR02WF.asp (1630) or UniversecomMISysHR02LSY.asp (1640). NetorusManagementHRU.asp (1600), NetorusManagementHRM.asp. (1610), NetorusManagementHRD.asp. (1620) all loop back to NetorusManagementHR.asp (1590) upon completion. FIG. 33 shows a flow chart of the log out function of the present invention. The Function SignOut.asp (1650) is used to loop the user whether authorized or unauthorized back to Default.asp (535).

The present invention is not limited to the sole embodiments described above, but encompasses any and all of the embodiments of the following claims.

1. A server side software program, comprising:
a means for a seller to enter multiple items for sale with one login to a server;
a means for the seller to enter multiple pictures with one login to the server;
a means for the seller to open the multiple pictures and to type a description, a preferred starting price, and an ending date for multiple auction sites with one login to the server;
a means for the seller to indicate to which of the multiple auction sites the seller wishes to post the multiple items for sale; and
a means for placing the description and the multiple pictures to multiple auction sites.

2. The program of claim 1, wherein the multiple pictures are associated with the multiple items for sale.

3. The program of claim 1, wherein said means for placing the description and the multiple pictures to multiple auction sites has a database of multiple accounts and passwords for multiple auction sites.

4. The program of claim 1, wherein said means for placing the description and the multiple pictures to multiple auctions sites has a means for logging into multiple auction sites.

5. The program of claim 1, wherein said means for the seller to enter multiple pictures uploads a stack of pictures from the seller's computer at once, instead of one picture at a time.

6. The program of claim 1, further comprising a means for providing basic bookkeeping functions for the seller.

7. The program of claim 6, wherein said means for providing basic bookkeeping functions for the seller includes charts or graphs to indicate which of the items for sale are selling at a faster rate.

8. The program of claim 6, wherein said means for providing basic bookkeeping functions for the seller includes designating which of the items for sale are selling at which auction site.

9. The program of claim 7, wherein the charts or graphs indicate which of the items for sale are selling at which auction site.
